(19) United States
(12) Patent Application Publication
(10) Pub. No.: US 2026/0168533 A1
(43) Pub. Date: Jun. 18, 2026

(54) ROLLING BEARING AND METHOD FOR PRODUCING A ROLLING BEARING CAGE

(71) Applicant: Schaeffler Technologies AG & Co. KG, Herzogenaurach (DE)

(72) Inventors: Serge Kursawe, Uttenreuth (DE); Pierre DUPONT, DOUR (BE)

(73) Assignee: Schaeffler Technologies AG & Co. KG, Herzogenaurach (DE)

(21) Appl. No.: 19/128,567

(22) PCT Filed: Jul. 21, 2023
(86) PCT No.: PCT/DE2023/100537

§ 371 Date: May 9, 2025

(30) Foreign Application Priority Data
Nov. 10, 2022 (DE) 10 2022 129 743.8

(51) Int. Cl. F16C 33/46; F16C 19/06; F16C 19/26; F16C 33/56

(52) U.S. Cl. CPC F16C 33/4611; F16C 19/06; F16C 19/26; F16C 33/565

(57) ABSTRACT

A rolling bearing, for example a spherical rolling bearing, such as for media lubrication, includes multiple bearing rings, rolling bodies which roll between the bearing rings, and a coated cage which guides the rolling bodies. The coating of the cage is produced in multiple layers and includes an NiP layer as a first layer. The NiP layer covers a cage main part which is made of a nonferrous metal, and a TiN layer as a cover layer.

### CROSS-REFERENCE TO RELATED APPLICATIONS

This application is the United States National Phase of International Application PCT/DE2023/100537, filed Jul. 21, 2023, which claims priority to German Application 10 2022 129 743.8, filed Nov. 10, 2022. The disclosures of the above applications are incorporated herein by reference.

### TECHNICAL FIELD

The disclosure relates to a rolling bearing, such as a roller bearing, having at least one coated component. The disclosure also relates to a method for producing a rolling bearing cage.

### BACKGROUND

A generic rolling bearing is known, for example, from DE 10 2006 057 484 B4. The known rolling bearing has roller-shaped rolling elements and a cylindrical bearing cage, where at least one lateral surface of the bearing cage is provided with a coating containing carbon and hydrogen. In the case of DE 10 2006 057 484 B4, the coating of the bearing cage is a metal-free coating. In contrast to this, bearing rings and/or rolling elements of the known rolling bearing have a metal-containing, carbon-containing coating. Possible metal contents include tungsten, titanium, cadmium, germanium, chromium, tantalum and nickel.

DE 102 18 238 A1 discloses a two-part, electrically conductive cage for rolling bearings. The electrically conductive cage has two cage halves that are held together by a metal bolt with thickened ends. The material of the metal bolt can be formed by way of resistance heating. This enables the production of form-fitting rivet heads.

DE 10 2016 212 200 A1 describes a cylindrical roller bearing including a rolling bearing cage. In this case, the rolling bearing cage is formed in one piece from two side rings arranged at a distance from one another and bracket webs connecting them. The cylindrical roller bearing according to DE 10 2016 212 200 A1 can be designed as a large bearing. Deep drawing and 3D printing are listed as technologies for producing the bearing cage.

WO 2007/104395 A1 discloses a hybrid bearing designed as a double-row angular contact ball bearing, which includes rolling element raceways made of steel and ceramic rolling elements, i.e., rollers. The hybrid bearing is intended to be operated without special lubricants and is designed for applications with low speeds and high axial loads.

If a bearing, such as a rolling bearing, is lubricated with a medium that is already present in the environment of the bearing but does not have the lubrication of the bearing as its main purpose, it is referred to as a medium-lubricated bearing. If a bearing is used in the open sea, for example, seawater is the medium that washes around the surfaces of bearing components instead of a lubricant. So-called media lubrication is therefore not considered as lubrication in the narrower sense. The corresponding substances can also be used for media lubrication in process engineering systems in which liquid or paste-like substances are conveyed. Typically, media lubrication places a particular load on the bearing in terms of wear.

### SUMMARY

The disclosure provides advances over the prior art in rolling bearings which are suitable for media lubrication, where a high wear resistance, even under tribologically unfavorable operating conditions, is sought.

The rolling bearing includes, in a basic concept known per se, bearing rings, which can be designed in one or more parts, rolling elements rolling between the bearing rings, and a cage with a coating guiding the rolling elements.

In some examples, the coating of the cage is produced in multiple layers, where it includes an NiP layer as the first layer and a TiN layer as the cover layer. The main part of the cage covered by the NiP layer is made of non-ferrous metal. For example, it is a brass cage.

The use of non-ferrous metal, such as brass, to produce the main part of the cage has the advantage that even if the coating is worn, steel-to-steel contact cannot occur, which would otherwise be conceivable if rolling elements and a cage made of steel were used. Rather, even in the event of a theoretically conceivable complete wearing down of the coating of the cage, the lubricating properties of the non-ferrous metal main part remain usable at least for emergency operation.

The first layer located directly on the main part, i.e., the layer containing nickel, has a thickness in the range from 2 μm to 30 μm, such as a thickness of 15±3 μm. The TiN cover layer deposited on this is, for example, 0.5 μm to 10 μm thick, such as 2±1 μm. In various typical examples covering a wide range of different bearing sizes, the thickness of the cover layer is at least 5% and not more than 20% of the total thickness of the multi-layer coating of the bearing cage.

In addition to the bearing cage, at least one other component of the rolling bearing, for example a bearing ring and/or the rolling elements, can also be provided with a coating. In contrast to the bearing cage, a coating containing carbon atoms can be used here. A suitable coating is a-C:H:W, marketed by the applicant as Triondur C. As far as carbon coatings are concerned, VDI Guideline 2840 “Carbon films—Fundamentals, film types, and properties” (09/2020) is relevant. This guideline deals with the characteristic properties of carbon coatings or films produced using physical or chemical vapor deposition (PVD or CVD) processes. In this context, reference is also made to the following publication of the applicant: “Triondur-Schichtsysteme für tribomechanisch hochbeanspruchte Oberflächen” [Triondur coating systems for tribomechanically highly stressed surfaces], Schaeffler Technologies AG & Co. KG, July 2019, TPI 115 D-D.

Triondur C is an amorphous carbon layer containing metal and hydrogen, which can be deposited using the PVD (physical vapor deposition) process and includes a very ductile layer structure and a hardness of more than 1200 HV. If the tungsten contained in a-C:H:W is replaced by any other metal (Me), the general composition a-C:H:Me is obtained.

Irrespective of the type of coating of various bearing components, the bearing cage of the rolling bearing can be designed as a solid brass cage in the form of a comb cage. Overall, the bearing is a double-row spherical rolling bearing. With regard to possible designs of spherical rolling bearings, reference is made to the documents DE 10 2019 104 395 A1 and DE 10 2018 120 592 A1 by way of example. Spherical rolling bearings are generally characterized by the fact that they can support high axial and radial loads and at the same time compensate for alignment errors.

The bearing cage suitable for use in the rolling bearing according to the application can be produced in the following steps:
depositing a nickel-containing layer on a non-ferrous metal main part of the cage in an electroless process, and
applying a cover layer of titanium nitride on the nickel-containing layer.

A nickel-phosphorus layer is suitable as a nickel-containing layer. With respect to the technological and scientific background, reference is made to the following dissertation: Christoph Wiegmann; “Charakterisierung von NiP-Schichten und alternativen Beschichtungssystemen als Verschleiß-und Korrosionsschutz auf Aluminiumknetlegierungen” [Characterization of NiP coatings and alternative coating systems as wear and corrosion protection on wrought aluminum alloys], TU Ilmenau, submission date: Dec. 11, 2017.

In the present case, the TiN layer covering the nickel-containing layer, such as the NiP layer, can be deposited using the PACVD (plasma-assisted chemical vapor deposition) process. During the production process, the NiP layer underneath the TiN layer serves as a diffusion barrier, which prevents lead contained in the brass alloy of the main part from outgassing during the PACVD process and interfering with the coating process. As a later layer component of the finished bearing cage, the NiP layer serves as a support layer for the much thinner, very hard TiN functional layer.

The medium used for media lubrication in connection with the rolling bearing according to the disclosure is, a plastic melt. For example, the plastic melt is used to lubricate the bearing at a temperature in the range of 150 to 200° C., preferably at a pressure in the order of 2000 bar.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a sectional perspective view of a rolling bearing,

FIG. 2 shows a sectional view of features of a coated cage of the rolling bearing according to FIG. 1,

FIG. 3 shows a detail of a coated rolling element of the rolling bearing according to FIG. 1,

FIG. 4 shows a detail of a coated bearing ring, namely an inner ring, of the rolling bearing according to FIG. 1.

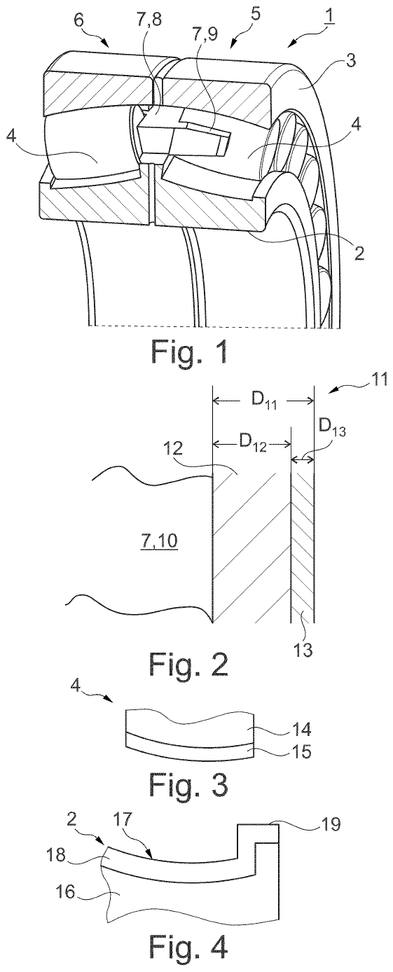

Like reference symbols in the various drawings indicate like elements.

### DETAILED DESCRIPTION

A rolling bearing, designated as a whole with the reference symbol 1, is designed as a double-row spherical rolling bearing. The rolling bearing 1 includes an inner ring 2 and an outer ring 3 as bearing rings 2, 3. Barrel rollers roll between the bearing rings 2, 3 as rolling elements 4, where as shown, there are two rows of rolling elements 5, 6 that are symmetrical to one another. Alternatively, the rolling bearing 1 could be designed as an asymmetrical spherical rolling bearing.

The rolling elements 4 are guided in a cage 7, which is designed as a comb cage and is mainly made of brass. The cage 7 has a cage ring 8 placed between the rows of rolling elements 5, 6, from which webs 9 extend, which project between the rolling elements 4 on both sides of the cage ring 8. The main part of the cage 7, i.e., the bearing cage, is made of brass and is designated with the reference symbol 10. A layer structure 11 is provided on the main part 10, which is illustrated in FIG. 2. The total thickness of the layer structure 11 is designated with D₁₁. The layer structure 11 includes a first layer 12 covering the main part 10 and a cover layer 13 located on top. In some examples, the thickness of the first layer 12, designated with D₁₂, is 15±3 μm. The cover layer 13 has a thickness D₁₃ in the range from 1 μm to 3 μm.

The first layer 12 is an NiP layer, which is applied to the main part 10 by way of electroless deposition and is also referred to as electroless nickel for short. The cover layer 13 is deposited as a titanium nitride layer on the first layer 12 using the PACVD process.

FIG. 3 shows the structure of the barrel-shaped rolling element 4. A main part 14 of the rolling element 4, i.e., the barrel roller, is made of standard bearing steel. There is a coating 15 on the main part 14, which contains carbon and hydrogen. In some examples, the coating 15 is provided in the form of a Triondur coating (a-C:H:W), as offered by the applicant for various fields of application.

The same type of coating, i.e., an amorphous carbon coating, is also provided on the inner ring 2, as sketched in FIG. 4, where in the case of the inner ring 2 the main part is designated with 16 and the coating with 18. Reference symbol 19 designates a rim of the inner ring 2. The rolling elements 4 roll on a rolling element raceway 17 of the inner ring 2. In a manner not shown, the outer ring 3 can also be coated in a corresponding manner. No special lubricant is used for the operation of the rolling bearing 1. Rather, the surfaces of the components 2, 3, 4, 7 of the rolling bearing 1 are wetted by a medium that flows in an apparatus to which the rolling bearing 1 can be attributed. The medium is, for example, a plastic melt that is present at a temperature in the range of 150 to 200° C. and at a pressure in the order of 2000 bar. The various layers 11, 15, 18 allow for low-wear operation of the rolling bearing 1 even under such extreme conditions.

A number of implementations have been described. Nevertheless, it will be understood that various modifications may be made without departing from the spirit and scope of the disclosure. Accordingly, other implementations are within the scope of the following claims.

### REFERENCE NUMERALS

1 Rolling bearing
2 Inner ring
3 Outer ring
4 Rolling element, barrel roller
5 Row of rolling elements
6 Row of rolling elements
7 Cage
8 Cage ring
9 Web
10 Main part of the cage
11 Layer structure of the cage
12 First layer, NiP layer
13 Cover layer, TiN layer
14 Main part of the barrel roller
15 Coating of the barrel roller
16 Main part of the inner ring
17 Rolling element raceway
18 Coating of the inner ring
19 Rim
D₁₁ Thickness of the entire layer structure
D₁₂ Thickness of the nickel layer
D₁₃ Thickness of the cover layer

1. A rolling bearing comprising:
bearing rings;
rolling elements (4) which roll between the bearing rings; and
a coated cage which guides the rolling elements, a coating of the coated cage is produced in multiple layers and comprises an NiP layer as a first layer, the NiP layer covering a main part of the coated cage which is made of a non-ferrous metal, and a TiN layer as a cover layer.

2. The rolling bearing of claim 1, wherein the NiP layer has a thickness of 2 μm to 30 μm.

3. The rolling bearing of claim 1, wherein the TiN layer (13) has a thickness of 0.5 μm to 10 μm.

4. The rolling bearing of claim 1, wherein at least one of the bearing rings has a carbon-containing coating.

5. The rolling bearing of claim 1, wherein the rolling elements are provided with a carbon-containing coating.

6. The rolling bearing of claim 4, wherein a-C:H:W is provided as the carbon-containing coating.

7. The rolling bearing of claim 1, wherein the cage is designed as a solid brass cage in a form of a comb cage.

8. The rolling bearing of claim 1, designed as a spherical rolling bearing.

9. A method for producing a rolling bearing cage, the method comprising:
depositing a nickel-containing layer on a non-ferrous metal main part of the cage in an electroless process; and
applying a cover layer of titanium nitride on the nickel-containing layer.

10. The method of claim 9, wherein the cover layer is applied by a PACVD process.
